(19) United States
(12) Patent Application Publication
(10) Pub. No.: US 2005/0077799 A1
(43) Pub. Date: Apr. 14, 2005

(54) Brush for the commutator of an electric machine

(76) Inventor: Jens Maerkle, Buehl (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 10/500,669

(22) PCT Filed: Sep. 25, 2002
(86) PCT No.: PCT/DE02/03620

(30) Foreign Application Priority Data
Feb. 16, 2002 (DE) 102 06 498.9

(51) Int. Cl. H02P 1/00; H02K 13/00

(52) U.S. Cl. 310/249; 361/239

(57) ABSTRACT

A brush for a commutator of an electrical machine, such as a generator or an electric motor wherein the brush includes a brush cable of oval cross section. The invention has the advantage that a narrower slot of a brush holder as a leadthrough for the brush cable and a smaller bending radius of the brush cable can be selected.

### PRIOR ART

The invention relates to a brush for a commutator of an electrical machine, having the characteristics of the preamble to claim 1. Electrical machines are for instance electric motors or generators; the brush of the invention is intended in particular for small motors with constricted installation space in the region of the commutator.

For electrically connecting the brushes of commutator machines, it is known to provide the brushes with a brush cable. The brushes are often carbon brushes and the brush cables are often pigtails, whose stripped or insulation-free ends are pressed into the brush and in this way joined mechanically to the brush and electrically contacted.

### EXPLANATION AND ADVANTAGES OF THE INVENTION

The brush of the invention having the characteristics of claim 1 has a brush cable with a non-circular cross section. Preferably, the cross section is oval or elliptical. Still other cross-sectional forms with transverse knives of different lengths in different directions can also be considered, such as a rectangular brush cable cross section.

The invention has the advantage that for a given cross-sectional area of the brush cable, a slot for passing the brush cable through in a brush holder, in which the brush rests displaceably, can be narrower than with a brush cable of circular cross section. In this way, good lateral guidance of the brush in the brush holder can be achieved.

Another advantage is that the brush cable of the invention can be bent with a shorter radius, or for a predetermined bending radius, it can have lesser tensile and compressive stresses than a brush cable of circular cross section and the same cross-sectional area. As a result, the brush of the invention with the brush cable can be accommodated in a more constricted installation space in the electrical machine, and the risk of oscillation breakage of the brush cable is reduced.

An additional advantage of the invention is that it can be produced in cost-neutral fashion, that is, at the same expense as a conventional brush. The brush of the invention can also be produced with the same pressing tool as a conventional brush; all that is needed is to replace a typically circular bush for supplying the brush cable with a bush of oval or elliptical cross section.

Because of the constricted installation space, the invention is especially intended for use in small motors, of the kind used for instance for opening and closing electrically powered sunroofs in motor vehicles.

### DRAWING

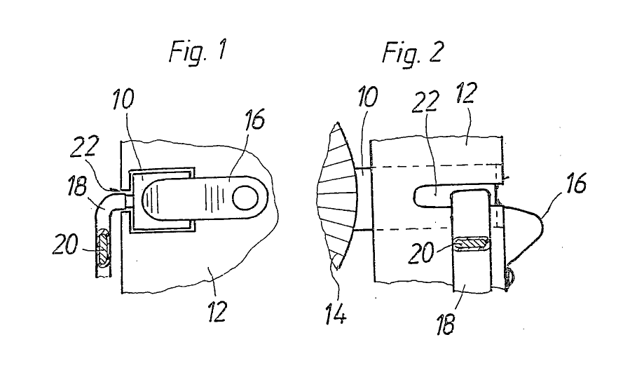

The invention will be described in further detail below in conjunction with an exemplary embodiment shown in the drawing. The two drawings show a brush holder with a brush of the invention, in an end view (FIG. 1) and in a side view (FIG. 2).

### DESCRIPTION OF THE EXEMPLARY EMBODIMENT

The brush 10 of the invention, shown in the drawing, is a so-called carbon brush, which rests in a brush holder 12 radially to a commutator 14 of an electrical machine, especially a small motor, that is not otherwise shown. A spring element 16 embodied as a leaf spring presses the brush 10 spring-elastically against a circumference of the commutator 14.

A stripped end of a pigtail is press-fitted into the brush 10 and forms a brush cable 18. The brush cable 18 has an oval cross-sectional area and is press-fitted into the brush 10 in such a way that a long semiaxis of the oval cross section is disposed in the displacement direction of the brush 10, and a short semiaxis is disposed transversely to the displacement direction. The cross section of the brush cable 18 is shown in FIG. 2 and identified by reference numeral 20. This disposition of the brush cable 18 makes a narrow slot 22 possible, as a leadthrough for the brush cable 18, in the brush holder 12. The brush cable 18 is guided displaceably on two opposed elongated sides of its oval cross section in the slot 22 of the brush holder 12 and thus in the same direction as the brush 10. For delivery to the brush 10, the brush cable 18 is bent transversely to the short semiaxis of its oval cross section, as a result of which a short bending radius is possible.

The production of the brush 10 of the invention is done in a manner known per se, by pressing in a pressing apparatus not shown. The pigtail that forms the brush cable 18 is delivered in production by a bush on an upper die of the pressing apparatus. Instead of a conventional circular bush, for producing the brush of the invention a bush of oval cross section is used for delivering the pigtail that forms the brush cable 18. An existing pressing apparatus can therefore be used to produce the brush 10 of the invention. Since such pressing apparatuses are known per se to one skilled in the art, they will not be described in further detail here.

1-6. (canceled)

7. In brush assembly for a commutator of an electrical machine, including a brush and a brush cable for delivering or drawing current, the improvement wherein the brush cable (18) has a non-circular cross section.

8. The brush of claim 7, wherein the brush cable (18) has transverse dimensions of different lengths in different directions.

9. The brush of claim 8, wherein the brush cable (18) has a rounded, non-circular cross section.

10. The brush of claim 9, wherein the brush cable (18) has an oval cross section.

11. The brush of claim 9, wherein the brush cable (18) has an elliptical cross section.

12. The brush of claim 7, wherein the brush cable (18) has two opposed elongated sides which are guided in a slot (22) of a brush holder (12).
